(19) United States
(12) Patent Application Publication
(10) Pub. No.: US 2015/0081393 A1
(43) Pub. Date: Mar. 19, 2015

(54) PRODUCT PROMOTION OPTIMIZATION SYSTEM

(71) Applicants: Massachusetts Institute of Technology, Cambridge, MA (US); Oracle International Corporation, Redwood Shores, CA (US)

(72) Inventors: Maxime Cohen, Cambridge, MA (US); Kiran Venkata Panchamgam, Woburn, MA (US); Ngai-Hang Zachary Leung, Cambridge, MA (US); Georgia Perakis, Belmont, MA (US)

(73) Assignees: Massachusetts Institute of Technology, Cambridge, MA (US); Oracle International Corporation, Redwood Shores, CA (US)

(21) Appl. No.: 14/030,287

(22) Filed: Sep. 18, 2013

(51) Int. Cl. G06Q 30/02

(52) U.S. Cl. CPC G06Q 30/0206
USPC 705/7.35

(57) ABSTRACT

A system that determines promotional pricing for a product and for an objective function receives a non-linear time-dependent optimization problem for the product, where the non-linear problem includes a demand model and a plurality of constraints, and the constraints include a price ladder that includes a plurality of time periods and a non-promotional price for the product at each time period. For each of the time periods, the system determines a change in the objective function when the price at that time period includes a promotional price and all other prices on the price ladder are set to the non-promotional price to generate coefficients. The system determines a maximum value of the coefficients at each time period, and generates an approximate Mixed Integer Programming (“MIP”) problem based on the coefficients. The system determines a Linear Programming (“LP”) relaxation of the MIP problem, and solves the LP relaxation.

### FIELD

One embodiment is directed generally to a computer system, and in particular to a product promotion optimization computer system.

### BACKGROUND INFORMATION

Product line pricing is an important business problem faced by retailers and other sellers of merchandise who employ dynamic pricing strategies to generate incremental revenue benefits throughout the year. Retailers, among others, have in increasing numbers begun to utilize decision support systems that leverage the large volume of detailed demand data to automate and optimize pricing recommendations. In particular, the statistical modeling of the price elasticity of items based on analyzing the effect of price changes of one product on its demand, or the demand for another product, can be used to optimize the pricing of products.

Further, many retailers use promotions as a driver to boost sales and/or profits. Promotions are temporary in the life cycle of the product, typically lasting a few weeks or less, and associated with a price discount over the regular price. Optimizing promotion pricing is a very challenging problem because the retailer has to decide on which products to promote, which promotional vehicles to use, what is the depth of price discount, and finally when to schedule the promotion.

### SUMMARY

One embodiment is a system that determines promotional pricing for a product and for an objective function. The system receives a non-linear time-dependent optimization problem for the product, where the non-linear problem includes a demand model and a plurality of constraints, and the constraints include a price ladder that includes a plurality of time periods and a non-promotional price for the product at each time period. For each of the time periods, the system determines a change in the objective function when the price at that time period includes a promotional price and all other prices on the price ladder are set to the non-promotional price to generate coefficients. The system determines a maximum value of the coefficients at each time period, and generates an approximate Mixed Integer Programming (“MIP”) problem based on the coefficients. The system determines a Linear Programming (“LP”) relaxation of the MIP problem, and solves the LP relaxation to generate a vector of promotional prices for the product at each time period along the pricing ladder.

### BRIEF DESCRIPTION OF THE DRAWINGS

FIG. 1 is a block diagram of a computer system that can implement an embodiment of the present invention.

FIG. 2 is a flow diagram of the functionality of the product promotion optimization module of FIG. 1 when determining optimized promotions for a product in accordance with one embodiment.

FIGS. 3a and 3b illustrate the quality of the ratio of the MIP optimal solution to the exact prior art optimal solution for a variety of input parameters.

FIGS. 4a and 4b illustrate the scalability of embodiments of the present invention in comparison to the prior art.

### DETAILED DESCRIPTION

One embodiment is a product promotion optimizer that determines optimized promotional pricing for a single product by determining incremental profit coefficients from a product optimization problem. The maximum values of the coefficients for each time period are determined and an approximate Mixed Integer Programming (“MIP”) problem is formulated. A linear programming relaxation of the MIP is determined and then solved to output the promotion pricing solution.

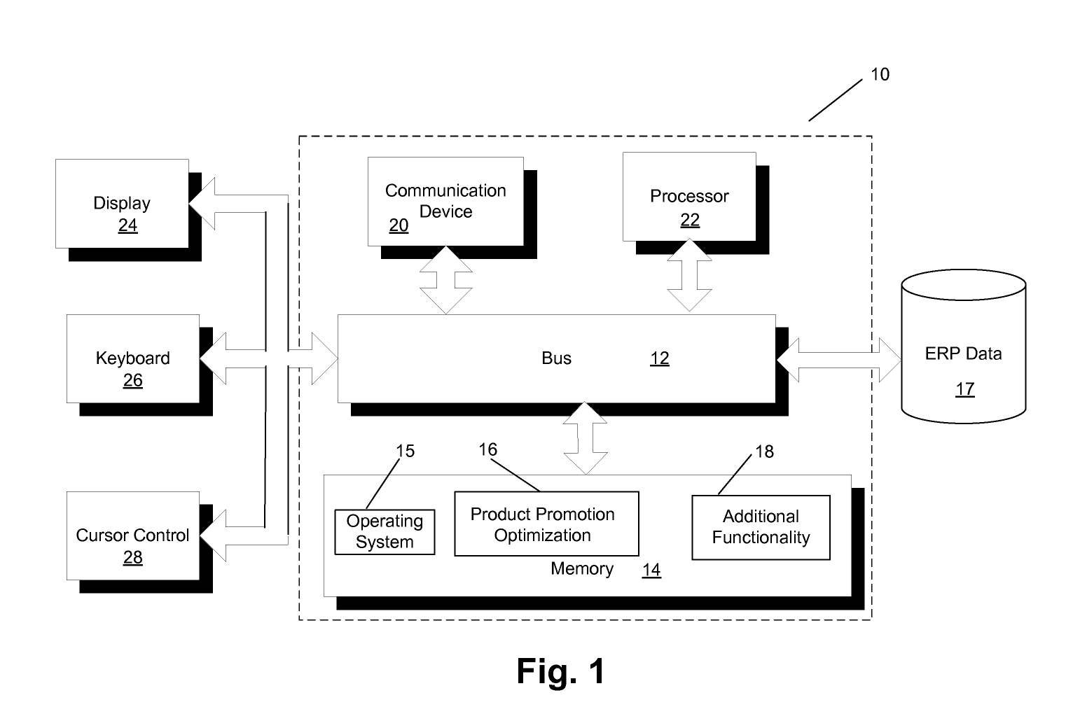

FIG. 1 is a block diagram of a computer system 10 that can implement an embodiment of the present invention. Although shown as a single system, the functionality of system 10 can be implemented as a distributed system. System 10 includes a bus 12 or other communication mechanism for communicating information, and a processor 22 coupled to bus 12 for processing information. Processor 22 may be any type of general or specific purpose processor. System 10 further includes a memory 14 for storing information and instructions to be executed by processor 22. Memory 14 can be comprised of any combination of random access memory (“RAM”), read only memory (“ROM”), static storage such as a magnetic or optical disk, or any other type of computer readable media. System 10 further includes a communication device 20, such as a network interface card, to provide access to a network. Therefore, a user may interface with system 10 directly, or remotely through a network or any other method.

Computer readable media may be any available media that can be accessed by processor 22 and includes both volatile and nonvolatile media, removable and non-removable media, and communication media. Communication media may include computer readable instructions, data structures, program modules or other data in a modulated data signal such as a carrier wave or other transport mechanism and includes any information delivery media.

Processor 22 is further coupled via bus 12 to a display 24, such as a Liquid Crystal Display (“LCD”), for displaying information to a user. A keyboard 26 and a cursor control device 28, such as a computer mouse, is further coupled to bus 12 to enable a user to interface with system 10.

In one embodiment, memory 14 stores software modules that provide functionality when executed by processor 22. The modules include an operating system 15 that provides operating system functionality for system 10. The modules further include a product promotion optimization module 16 that generates optimized product promotion pricing, as disclosed in more detail below. System 10 can be part of a larger system, such as “Retail Demand Forecasting” from Oracle Corp. or an enterprise resource planning (“ERP”) system. Therefore, system 10 will typically include one or more additional functional modules 18 to include the additional functionality. A database 17 is coupled to bus 12 to provide centralized storage for modules 16 and 18 and store pricing information, inventory information, ERP data, etc.

One embodiment provides product promotion optimization for a retailer that has a single product and a single vehicle for informing the promotion to customers. The retailer desires to maximize some objective function (e.g., total profits, revenues, gross margins, etc.) over a finite period of time (e.g., a quarter) where the demand is expressed as a nonlinear time-dependent function of the prices, which can take values only from a discrete price ladder.

Embodiments formulate a promotion optimization problem that minimizes or maximizes a nonlinear time-dependent objective function (e.g., the total aggregated profits) of discrete variables subject to certain constraints. An objective function is calculated for all the different time periods where demand for each item is expressed as a nonlinear function of all item prices, which can take values only from specific price ladders. This maximization problem can be stated as follows: Find the best prices (p₁, . . . , p_{T}) at each time-period over the selling season T so as to maximize the total aggregated profits (or any other alternative objective function) subject to some constraints motivated by the business rules.

One embodiment begins with a demand model that incorporates a reference price effect. A reference price, in general, characterizes the price that consumers are willing to pay at time t depending on historical posted prices and their memory of past pricing. Embodiments model the reference price effect in a log-log form for modeling demand, as a function of the price, in which the demand at time t is as follows:

$$log {d}_{t} ( {p}_{t} , {r}_{t} ) = {β}_{t} + {β}^{price} log \frac{{p}_{t}}{{q}^{0}} + {β}^{gain} \frac{{( {r}_{t} - {p}_{t} )}^{+}}{{q}^{0}} + {β}^{loss} \frac{{( {p}_{t} - {r}_{t} )}^{+}}{{q}^{0}}$$

where βₜ, β^{price}, β^{gain} and β^{loss} represent the market share along with demand seasonality, the price elasticity parameter and the reference price gain and loss parameters, respectively. In general, the reference price effect on the demand is asymmetric. The “+” operator is defined by: (x)⁺=max(x,0). Embodiments do not assume any demand form.

Embodiments incorporate several business requirements/rules and consider a finite horizon window. Examples of such business rules include natural limitations on price variations (e.g., the price of the item can be modified only 20% of the time) and a no-touch constraint (e.g., two promotions have to be separated by some idle time). In addition, embodiments allow the demand at time t to depend on past prices in order to capture the promotion fatigue effect observed in retail environments. For example, discounting the price at time twill increase the demand at that time but also might decrease the demand at some future times. For example, some customers may buy larger quantities due to the attractive discount. This phenomenon is known as “stockpiling” and embodiments capture this factor by using a reference price propagation effect on the demand. In one embodiment, the following constraints are considered:

Demand Model:

One embodiment uses a demand model that assumes infinite population with myopic (non-strategic) customers. The demand at time t is expressed as a given non-linear and time-dependent function dₜ=fₜ(pₜ,rₜ), where rₜ denotes the reference price at time t and is assumed to follow an exponential smoothing relation given by:

rₜ=θ·rₜ₋₁+(1−θ)·pₜ₋₁

Where 0≦θ<1 represents a memory parameter and r₁ is the initial reference price (given or estimated from data). Therefore, the demand at time twill implicitly depend on all the past prices.

Price Ladder:

In one embodiment, the price ladder is expressed as {q⁰, . . . , q^{K}}, where q⁰ is the regular price. The demand model can generalize for the cases where the regular price q⁰ is time dependent. Binary variables αₜ^{k} are equal to 1 if the price at time t is set to q^{k} and 0 otherwise.

No-Touch Constraint:

This rule models the fact that two successive promotions should be separated by some time period.

Limitation on Price Changes:

Retailers impose such a restriction since frequent promotions devalues the way customers perceive an item. In addition, this rule can be motivated by high labeling costs and other business requirements.

The notation used to define the promotion optimization problem in accordance with embodiments of the present invention is as follows:
fₜ(pₜ,rₜ) is a non-linear time-dependent expression for the demand at time t as a function of the price and the reference price at that time period.
q⁰ is the regular price (given). It can be time-dependent.
q^{k} is the k^{th} element of the price ladder.
T is the length of the time horizon (e.g. one quarter).
θ is the memory parameter.
c is the cost (given).
pₜ and rₜ are the price and the reference price at time t respectively.
S represents the no-touch period (minimal period of time between two successive price changes).
L is the imposed limitation on the number of price changes (one can vary the price L times out of Tfrom the regular price).
αₜ^{k} are binary variables that indicate if we select the price q^{k} at time t.

The promotion optimization problem in accordance with embodiments can be formally defined as follows (referred to as the “promotion optimization problem”):

$$\begin{matrix}{ max}_{{α}_{t}^{k}} {\sum }_{t = 1}^{T} ( {p}_{t} - c ) {d}_{t} ( {p}_{t} , {r}_{t} ) & \begin{matrix} ( Objective function \text{-} \\ e . g . total profits )\end{matrix} \\ s . t . {r}_{1} = initial reference price ( from data ) & \\ {r}_{t} = θ {r}_{t - 1} + ( 1 - θ ) {p}_{t - 1} t = 2 , 3 , … & ( Reference price propagation ) \\ {p}_{t} = {\sum }_{k = 0}^{K} {q}^{k} {α}_{t}^{k} & ( Price at time t ) \\ {\sum }_{τ = t}^{t + S} {α}_{t}^{k} \leq 1 ∀ t & ( No \text{-} touch constraint ) \\ {\sum }_{t = 1}^{T} {\sum }_{k = 1}^{K} {α}_{t}^{k} \leq L & ( Limitation on price changes ) \\ {\sum }_{k = 1}^{K} {α}_{t}^{k} = 1 ∀ t & ( Only a single price is used ) \\ {α}_{t}^{k} ∈ \{ 0 , 1 \} & \end{matrix}$$

The general class of problems such as the promotion optimization problem disclosed above is known to be difficult to solve to optimality and even finding a high-quality approximate solution is intractable. Since in general the profit function cannot be assumed to be convex or concave, these problems cannot be solved using gradient methods after the price ladder constraint is relaxed and price variables are considered continuous. In addition, enumeration is clearly not tractable as the number of possibilities grows exponentially very fast. Further, solving the above promotion optimization problem becomes even more challenging when the time dependence of demand on past prices is added (i.e., reference price) as with embodiments of the present invention.

As discussed above, embodiments formulate a Mixed Integer Programming (“MIP”) approximation for the non-linear time-dependent demand function of promotion optimization problem. In addition, instead of solving the MIP problem, embodiments solve a Linear Programming (‘LP”) relaxation of the MIP problem so that the model in accordance with embodiments of the present invention is efficient and tractable.

Embodiments obtain a high-quality approximate solution to the promotion optimization problem by taking advantage of the discrete nature of the variables. Embodiments also work for a general class of problems with any non-linear demand and allow the incorporation of the business requirements of interest for the problem. In addition, embodiments allow various input parameters to be chosen, including the objective function, the allowed number of price changes and the no-touch period. Embodiments reduce the problem to solving a Linear Programming problem so that a solution can be provided efficiently, and is scalable.

Embodiments assume that the inventory is always available, so that the demand is equal to the sales. Embodiments further assume that the sales in a given time period (e.g., week) depend on the price of that time period (e.g., week) as well as on the reference price for the item (can be any time-dependent function).

Embodiments are given the current value of the non-promoted price q° and the objective is to find a new price at each time period over the time horizon that maximizes a given objective function and satisfies the business requirements such as price limitations and the no-touch constraint. The price ladder typically includes prices that are lower than the regular price but in some embodiments can be extended for any type of price ladder that can potentially include prices higher than the regular price.

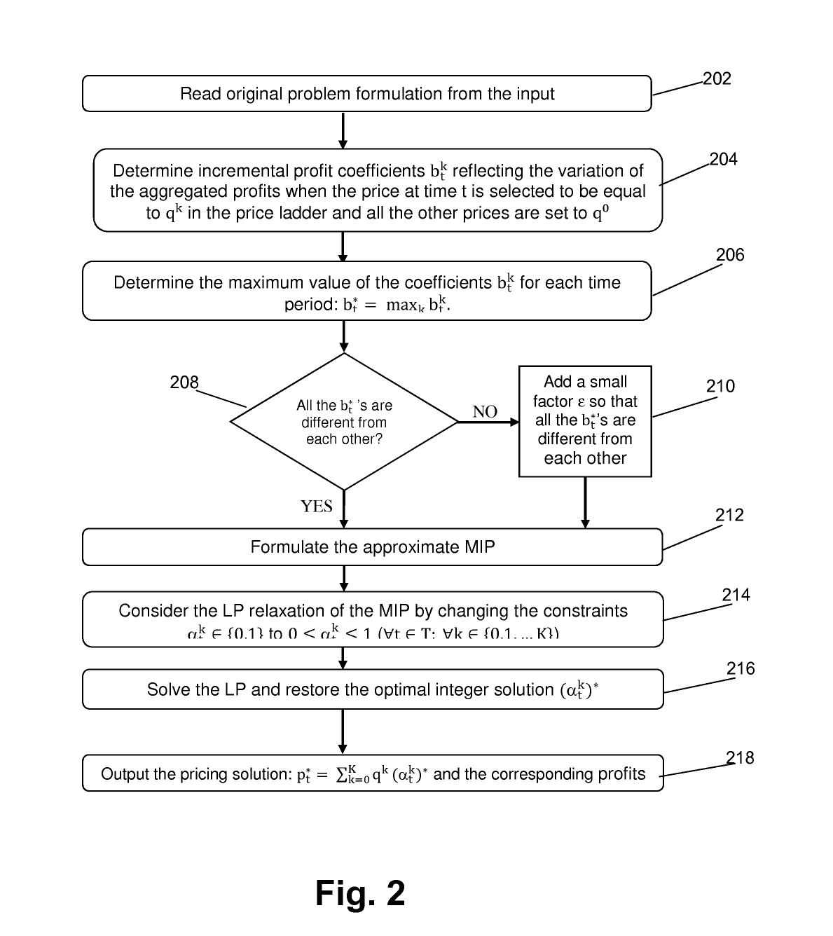

FIG. 2 is a flow diagram of the functionality of product promotion optimization module 16 of FIG. 1 when determining optimized promotions for a product in accordance with one embodiment. In one embodiment, the functionality of the flow diagram of FIG. 2 is implemented by software stored in memory or other computer readable or tangible medium, and executed by a processor. In other embodiments, the functionality may be performed by hardware (e.g., through the use of an application specific integrated circuit (“ASIC”), a programmable gate array (“PGA”), a field programmable gate array (“FPGA”), etc.), or any combination of hardware and software.

At 202, the original, generally non-linear time-dependent promotion optimization problem as disclosed above is read from the input stream. The promotion optimization problem includes a demand model, an objective function, and constraints.

At 204, for each time period and each price ladder element of the problem, the changes in the total aggregated profits (or any other alternative objective function) are determined when the price at time t is selected to be equal to q^{k} in the price ladder and all the other prices are set to q⁰ (i.e., the regular non-promotion price). These coefficients will be positive when the corresponding change in price is overall profitable relative to the non-promotion price.

At 206, the maximum value of the coefficients bₜ^{k} for each time period: bₜ*=maxₖbₜ^{k} is determined. There is a total of T such coefficients.

At 208, it is determined if the brs are different from each other. If yes at 208, functionality continues at 212.

If no at 208 (i.e., all the bₜ*'s are not different from each other), at 210 a small factor ε is added to some of the bₜ*'s so that all the bₜ*'s are different from each other. The purpose is to avoid ties so that a unique optimal solution is generated and is guaranteed to be integer valued. Further, the value of the optimal solution of the MIP, disclosed in detail below, is not affected by the addition of a small factor. In one embodiment, the value of ε can be approximately equal to 5% of the minimal of the bₜ*'s.

At 212, an approximate MIP is formulated where the objective function to be maximized (e.g., total profits) is calculated as the sum of the incremental profits of having one price change at a time. More specifically, the objective is approximated by the sum of the products of the coefficients calculated at 204 with the decision variables αₜ^{k}. Mathematically, the objective is approximated by: π(p⁰)+Σₜ₌₁^{T}Σₖ₌₁^{K}bₜ^{k}αₜ^{k}, where) π(p⁰) is the objective function when all the prices are equal to q⁰. All other constraints of the original product optimization problem are linear by definition and do not need to be changed. The MIP formulation in accordance with one embodiment is disclosed in detail below.

At 214, the LP relaxation of the MIP from 212 is considered by modifying the constraints αₜ^{k}ε{0,1} to 0≦αₜ^{k}≦1 (∀tεT; ∀kε{0,1, . . . K}).

At 216, the LP formulated at 214 is solved by an LP solver. At 216, the LP formulated at 214 is solved by an LP solver. Examples of known LP solvers include Cplex, XPRESS MP, Gurobi, etc. The optimal integer solution (αₜ^{k})* is restored.

At 218, the pricing solution to the original problem and the corresponding profits are written to the output stream for reporting and other interface purposes. The pricing solution is a vector of prices for the product corresponding to dates on the pricing ladder in the form of pₜ*=Σₖ₌₀^{K}q^{k}αₜ^{k}.

Further details of the MIP formulation disclosed in conjunction with 212 of FIG. 2 is as follows. First, the total aggregated profits over the time horizon when all the prices are set to q⁰ is denoted by π(p⁰). A set of coefficients is then introduced to express the difference between the aggregated profits when only one price is changed (and equal to a specific q^{k}) and π(p⁰):

bₜ^{k}=π(pₜ^{k})−π(p⁰)

Where π(pₜ^{k}) represents the total aggregated profits where the price at time t is equal to q^{k} and all the remaining prices are equal to q⁰.

As previously disclosed, the set of binary decision variables αₜ^{k} indicates whether the price at time t was assigned to the k^{th} price in its ladder:

$${α}_{t}^{k} = \{ \begin{matrix}1 & if {p}_{t} = {q}^{k} , \\ 0 & otherwise .\end{matrix}$$

Finally, the MIP problem is formulated:

$${max}_{{α}_{t}^{k}} MIP ( α ) := π ( {p}^{0} ) + {\sum }_{t = 1}^{T} {\sum }_{k = 1}^{K} {b}_{t}^{k} {α}_{t}^{k}$$

$$s . t . {\sum }_{τ = 1}^{t + S} {\sum }_{k = 1}^{K} {α}_{t}^{k} \leq 1 ∀ t$$

$${\sum }_{t = 1}^{T} {\sum }_{k = 1}^{K} {α}_{t}^{k} \leq L$$

$${\sum }_{k = 0}^{K} {α}_{t}^{k} = 1 ∀ t$$

$${α}_{t}^{k} ∈ \{ 0 , 1 \} ∀ t , k$$

The above MIP problem maximizes the total aggregated profits over the finite time horizon T without a discount factor. In other embodiments, a general objective function can be used instead. Further, in some embodiments a constraint on different price ladders at each time period and more complicated restrictions on the price changes can be incorporated.

The pricing solution output at 218 of FIG. 2 serves as an approximation to the exact solution of the original promotion optimization problem disclosed above. Specifically, the solution guarantees that exactly one at variable is equal to one at each time t so that the final vector of prices can be easily determined: pₜ*=Σₖ₌₀^{K}q^{k}αₜ^{k}. Finally, the constraints on feasible prices are similar than the ones in the original formulation.

As disclosed, embodiments are able to find a near-optimal solution for the promotional optimization problem for a single product. Further, embodiments can be used to approximate the more general problem with multiple items by solving the single item problem as a subroutine (i.e., solving the single item problem multiple times).

Embodiments are scalable and yield a near-optimal solution and adds value to the retailer. In order to verify the effectiveness of embodiments, a comparison was made between solving the promotion optimization problem using the MIP solution in accordance with embodiments of the present invention to the prior art optimal solution obtained using exact approach. In general, the prior art exact approach involves an exhaustive enumeration, or formulating an integer program with a non-linear objective function. However, these prior art approaches are generally not scalable for large size problems.

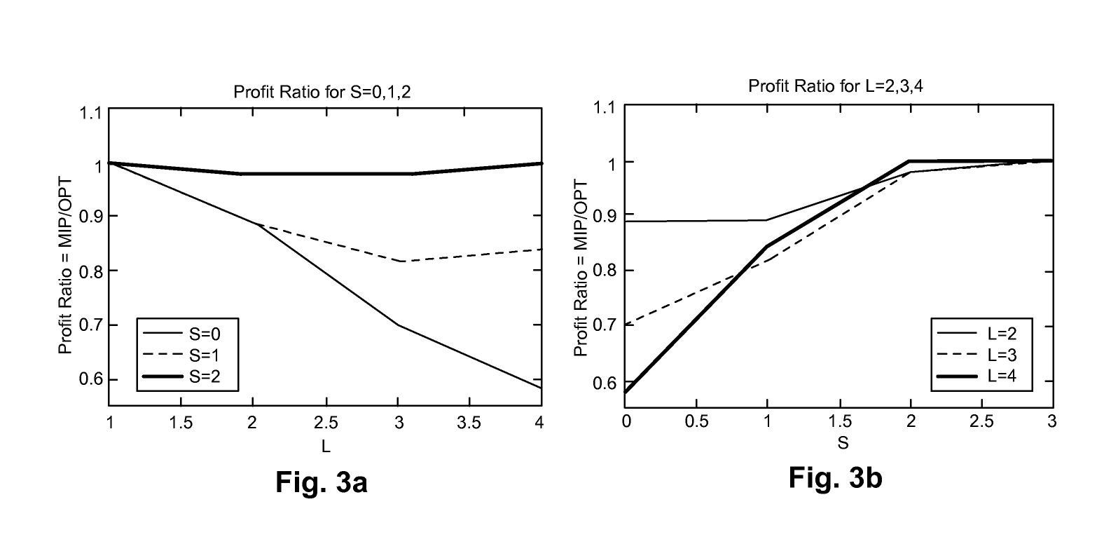

FIGS. 3a and 3b illustrate the quality of the ratio of the MIP optimal solution (i.e., embodiments of the invention) to the exact prior art optimal solution for a variety of input parameters, “S” (FIG. 3a) and “L” (FIG. 3b). The S parameter is the time between promotions, and the L parameter is the number of promotions, as described above. As shown, the ratio is very close to 1 between the two methods, which indicates that the quality of the solution in accordance to embodiments of the invention is acceptable for most practical situations.

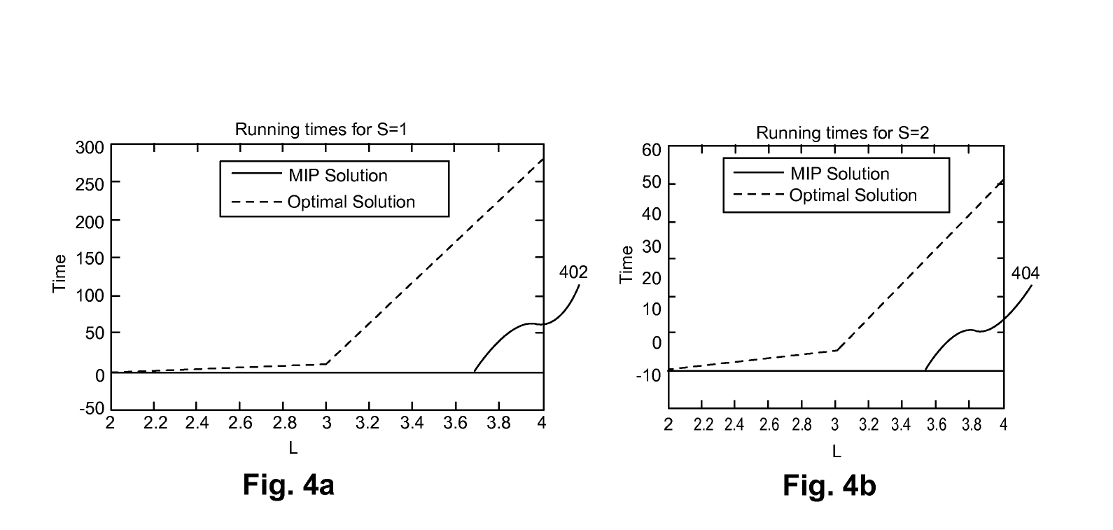

FIGS. 4a and 4b illustrate the scalability of embodiments of the present invention (referred to as the “MIP Solution” and shown as line 402 of FIG. 4a and line 404 of FIG. 4b) in comparison with the prior art (referred to as the “Optimal Solution”). As shown, the time to find the MIP solution in accordance with embodiments of the invention is generally constant regardless of the size of the problem (indicated by the increasing number of S and L parameters. However, the prior art exact optimal approach grows exponentially to the size of the problem, to the point where it may become impractical to execute in an efficient and timely manner.

As disclosed, embodiments generate optimized product promotion pricing for a single product in which pricing falls on a pricing ladder. The original promotion problem is formulated as an approximate MIP by determining incremental profit coefficients. An LP relaxation of the MIP is determined and the LP is solved to generate a vector of promotion pricing for the product.

Several embodiments are specifically illustrated and/or described herein. However, it will be appreciated that modifications and variations of the disclosed embodiments are covered by the above teachings and within the purview of the appended claims without departing from the spirit and intended scope of the invention.

What is claimed is:

1. A computer readable medium having instructions stored thereon that, when executed by a processor, cause the processor to determine promotional pricing for a product and for an objective function, the determination comprising:
receiving a non-linear time-dependent optimization problem for the product, wherein the non-linear problem comprises a demand model and a plurality of constraints, wherein the constraints comprise a price ladder that comprises a plurality of time periods and a non-promotional price for the product at each time period;
for each of the time periods, determining a change in the objective function when the price at that time period comprises a promotional price and all other prices on the price ladder are set to the non-promotional price to generate coefficients;
determining a maximum value of the coefficients at each time period;
generating an approximate Mixed Integer Programming (MIP) problem based on the coefficients;
determining a Linear Programming (LP) relaxation of the MIP problem; and
solving the LP relaxation to generate a vector of promotional prices for the product at each time period along the pricing ladder.

2. The computer readable medium of claim 1, wherein the objective function comprises at least one of: total profits, gross revenues or gross margins.

3. The computer readable medium of claim 1, wherein the optimization problem comprises time-dependent reference pricing for the product.

4. The computer readable medium of claim 1, wherein the plurality of constraints comprise at least one of: a no-touch constraint or a limitation on price changes.

5. The computer readable medium of claim 1, further determining if all of the coefficients are different from each other.

6. The computer readable medium of claim 1, further comprising summing the products of each of the coefficients and binary decision variables, wherein each binary decision variable comprises either 0 or 1.

7. The computer readable medium of claim 5, further comprising adding a factor to one or more of the coefficients when the coefficients are not different from each other.

8. A method of determining promotional pricing for a product and for an objective function, the method comprising:
receiving a non-linear time-dependent optimization problem for the product, wherein the non-linear problem comprises a demand model and a plurality of constraints, wherein the constraints comprise a price ladder that comprises a plurality of time periods and a non-promotional price for the product at each time period;
for each of the time periods, determining a change in the objective function when the price at that time period comprises a promotional price and all other prices on the price ladder are set to the non-promotional price to generate coefficients;
determining a maximum value of the coefficients at each time period;
generating an approximate Mixed Integer Programming (MIP) problem based on the coefficients;
determining a Linear Programming (LP) relaxation of the MIP problem; and
solving the LP relaxation to generate a vector of promotional prices for the product at each time period along the pricing ladder.

9. The method of claim 8, wherein the objective function comprises at least one of: total profits, gross revenues or gross margins.

10. The method of claim 8, wherein the optimization problem comprises time-dependent reference pricing for the product.

11. The method of claim 8, wherein the plurality of constraints comprise at least one of: a no-touch constraint or a limitation on price changes.

12. The method of claim 8, further determining if all of the coefficients are different from each other.

13. The method of claim 8, further comprising summing the products of each of the coefficients and binary decision variables, wherein each binary decision variable comprises either 0 or 1.

14. The method of claim 12, further comprising adding a factor to one or more of the coefficients when the coefficients are not different from each other.

15. A system for determining promotional pricing for a product comprising:
an objective function change determination module that receives a non-linear time-dependent optimization problem for the product, wherein the non-linear problem comprises a demand model and a plurality of constraints, wherein the constraints comprise a price ladder that comprises a plurality of time periods and a non-promotional price for the product at each time period, and for each of the time periods, and determines a change in an objective function when the price at that time period comprises a promotional price and all other prices on the price ladder are set to the non-promotional price to generate coefficients;
a Mixed Integer Programming (MIP) generator that determines a maximum value of the coefficients at each time period and generates a MIP problem based on the coefficients; and
a Linear Programming (LP) solver that determines an LP relaxation of the MIP problem and solves the LP relaxation to generate a vector of promotional prices for the product at each time period along the pricing ladder.

16. The system of claim 15, the objective function change determination module further determining if all of the coefficients are different from each other.

17. The system of claim 16, the objective function change determination module further adding a factor to one or more of the coefficients when the coefficients are not different from each other.

18. The system of claim 15, the MIP generator further summing the products of each of the coefficients and binary decision variables, wherein each binary decision variable comprises either 0 or 1.

19. The system of claim 15, wherein the objective function comprises at least one of: total profits, gross revenues or gross margins.

20. The system of claim 15, wherein the optimization problem comprises time-dependent reference pricing for the product.
